(19) United States
(12) Patent Application Publication
(10) Pub. No.: US 2005/0076325 A1
(43) Pub. Date: Apr. 7, 2005

(54) Automatic software update of nodes in a network data processing system

(75) Inventors: Helen R. Bergin, Austin, TX (US); Bryan Christopher Chagoly, Austin, TX (US); Nduwuisi I. Emuchay, Austin, TX (US)

Correspondence Address: IBM CORP (YA);C/O YEE & ASSOCIATES PC, P.O. BOX 802333, DALLAS, TX, 75380, US

(73) Assignee: International Business Machines Corporation, Armonk, NY (US)

(21) Appl. No.: 10/677,658

(22) Filed: Oct. 2, 2003

(51) Int. Cl. G06F 9/44

(52) U.S. Cl. 717/100

(57) ABSTRACT

A method, apparatus, and computer instructions for managing software updates in a network data processing system. An update for an application is identified for distribution to customers from a supplier. The update is distributed through a supplier controlled process to a customer network based on customer access information for a customer owning the customer network.

### BACKGROUND OF THE INVENTION

1. Technical Field

The present invention relates generally to an improved data processing system and in particular to a method and apparatus for updating or maintaining software in a network data processing system. Still more particularly, the present invention relates to a method, apparatus, and computer instructions for automatically updating software in a network data processing system.

2. Description of Related Art

The Internet, also referred to as an “internetwork”, is a set of computer networks, possibly dissimilar, joined together by means of gateways that handle data transfer and the conversion of messages from a protocol of the sending network to a protocol used by the receiving network. When capitalized, the term “Internet” refers to the collection of networks and gateways that use the TCP/IP suite of protocols.

The Internet has become a cultural fixture as a source of both information and entertainment. Many businesses are creating Internet sites as an integral part of their marketing efforts, informing consumers of the products or services offered by the business or providing other information seeking to engender brand loyalty. Many federal, state, and local government agencies are also employing Internet sites for informational purposes, particularly agencies which must interact with virtually all segments of society such as the Internal Revenue Service and secretaries of state. Providing informational guides and/or searchable databases of online public records may reduce operating costs. Further, the Internet is becoming increasingly popular as a medium for commercial transactions.

Currently, the most commonly employed method of transferring data over the Internet is to employ the World Wide Web environment, also called simply “the Web”. Other Internet resources exist for transferring information, such as File Transfer Protocol (FTP) and Gopher, but have not achieved the popularity of the Web. In the Web environment, servers and clients effect data transaction using the Hypertext Transfer Protocol (HTTP), a known protocol for handling the transfer of various data files (e.g., text, still graphic images, audio, motion video, etc.). The information in various data files is formatted for presentation to a user by a standard page description language, the Hypertext Markup Language (HTML). In addition to basic presentation formatting, HTML allows developers to specify “links” to other Web resources identified by a Uniform Resource Locator (URL). A URL is a special syntax identifier defining a communications path to specific information. Each logical block of information accessible to a client, called a “page” or a “Web page”, is identified by a URL. The URL provides a universal, consistent method for finding and accessing this information, not necessarily for the user, but mostly for the user's Web “browser”. A browser is a program capable of submitting a request for information identified by an identifier, such as, for example, a URL. A user may enter a domain name through a graphical user interface (GUI) for the browser to access a source of content. The domain name is automatically converted to the Internet Protocol (IP) address by a domain name system (DNS), which is a service that translates the symbolic name entered by the user into an IP address by looking up the domain name in a database.

The Internet also is widely used to transfer applications to users using browsers. With respect to commerce on the Web, individual consumers and business use the Web to purchase various goods and services. In offering goods and services, some companies offer goods and services solely on the Web while others use the Web to extend their reach. In particular, many businesses and organizations have begun relying on the Internet to distribute software as well as software updates to customers.

With the current system, managers and administrators of network data processing systems must initiate contact with a supplier site to identify new updates to existing products. For example, the administrator or manager of a customer network data processing system must check a supplier Web site to see if new patches exist for each one of the products that the customer currently uses. Then, the customer is required to read the install notes to see if any prerequisites or dependencies are present for the patch prior to installation. Once the customer has verified this information, the patch is then downloaded to the desired machine and installed. This process leaves no trace of when the patch was downloaded and installed. Further, the procedure also is error prone. For example, patches may be easily installed in the wrong order causing the product to be inoperable or unusable.

Therefore, it would be advantageous to have an improved method, apparatus, and computer instructions for automatically updating software in a network data processing system.

### SUMMARY OF THE INVENTION

The present invention provides a method, apparatus, and computer instructions for managing software updates in a network data processing system. An update for an application is identified for distribution to customers from a supplier. The update is distributed through a supplier controlled process to a customer network based on customer access information for a customer owning the customer network.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which the present invention may be implemented;

FIG. 2 is a block diagram of a data processing system that may be implemented as a server in accordance with a preferred embodiment of the present invention;

FIG. 3 is a block diagram illustrating a data processing system in which the present invention may be implemented;

FIG. 4 is a block diagram illustrating components used in an automatic software update of nodes in a network data processing system in accordance with a preferred embodiment of the present invention;

FIG. 5 is a flowchart of a process for receiving updates in accordance with a preferred embodiment of the present invention;

FIG. 6 is a flowchart of a process for receiving updates from a server in accordance with a preferred embodiment of the present invention;

FIG. 7 is a flowchart of a process for requesting an update in accordance with a preferred embodiment of the present invention;

FIG. 8 is a flowchart of a process for requesting an inventory update in accordance with a preferred embodiment of the present invention; and

FIG. 9 is a flowchart of a process used for identifying customer updates in accordance with a preferred embodiment of the present invention.

### DETAILED DESCRIPTION OF THE PREFERRED EMBODIMENT

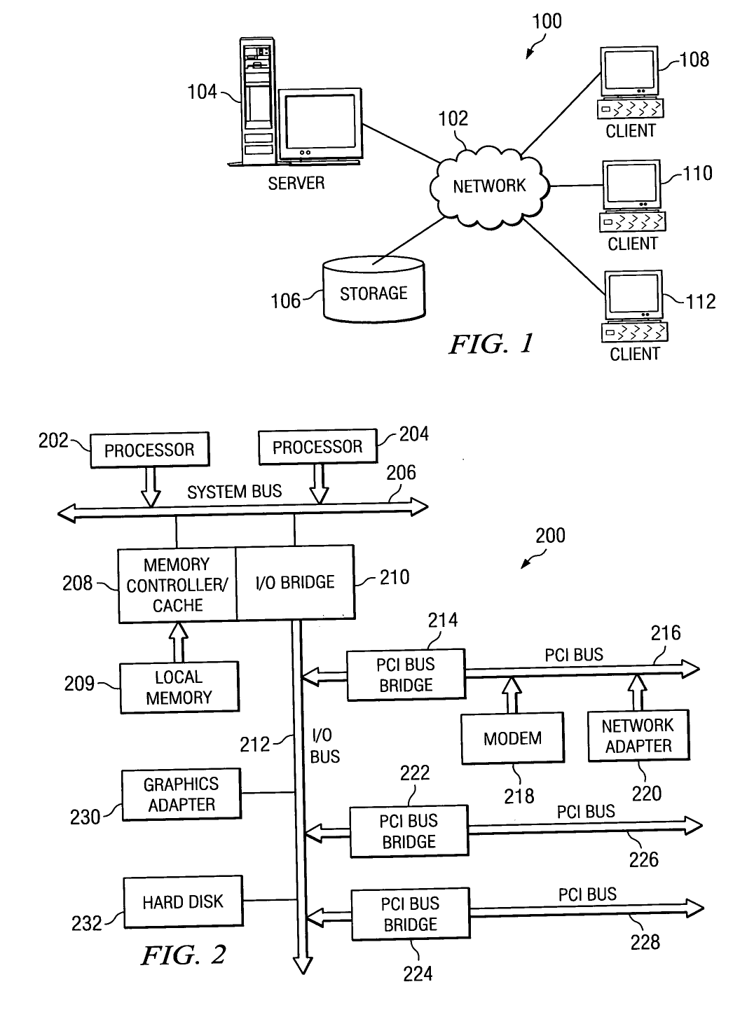

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, operating system images, and applications to clients 108-112. Clients 108, 110, and 112 are clients to server 104. Network data processing system 100 may include additional servers, clients, and other devices not shown. In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors.

Communications links to clients 108-112 in FIG. 1 may be provided through modem 218 and network adapter 220 connected to PCI local bus 216 through add-in boards. Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM eServer pSeries system, a product of International Business Machines Corporation in Armonk, N.Y., running the Advanced Interactive Executive (AIX) operating system or LINUX operating system.

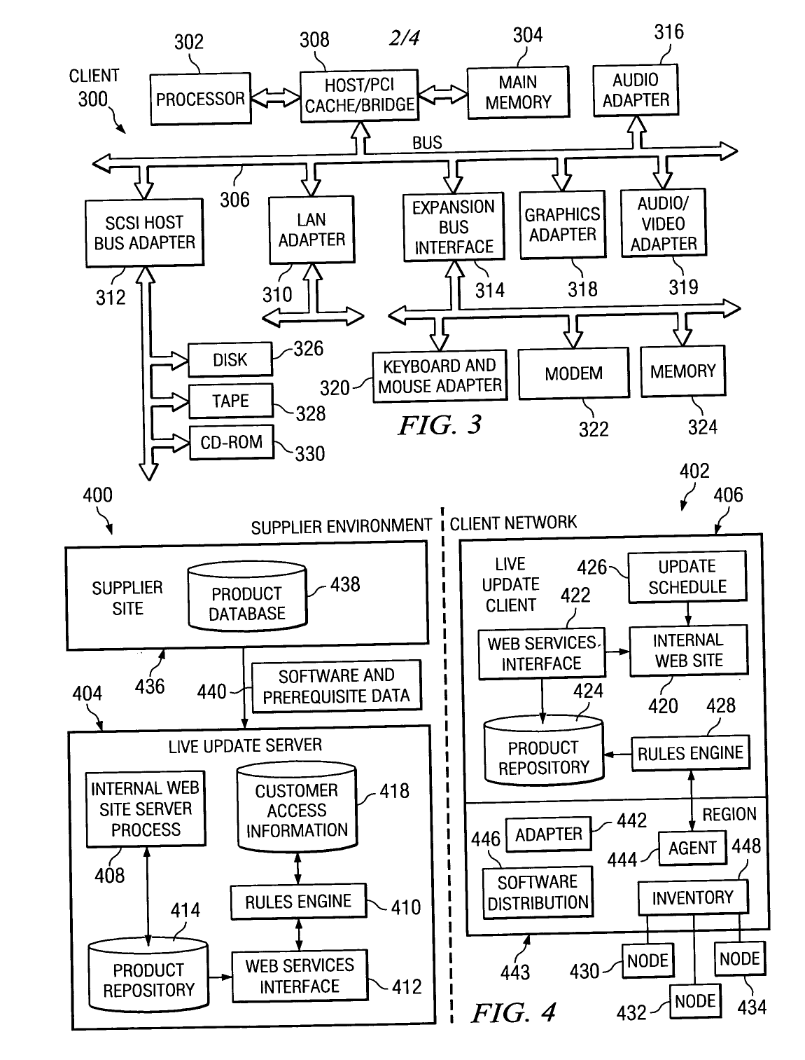

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows XP, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented programming system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash read-only memory (ROM), equivalent nonvolatile memory, or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interfaces. As a further example, data processing system 300 may be a personal digital assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

The present invention provides an improved method, apparatus, and computer instructions for installing and updating software on a customer network. In the depicted examples, a live update server controlled by a supplier is used in conjunction with a live update client on a customer network to seamlessly deliver software updates. These software updates include, for example, patches, efixes, and new applications. The mechanism of the present invention provides a communications process between the supplier and customers to facilitate the automatic detection of needed patches and fixes in a customer network environment.

The mechanism of the present invention also is able to control the updating of software such that a customer only receives updates that are authorized based on customer access information. The distribution of updates may occur either in a push or pull mechanism. In these examples, a push mechanism involves the supplier sending updates to a customer based on a schedule or set of events defined by the supplier. The pull mechanism involves the customer requesting updates from the supplier. In particular, the mechanism of the present invention may be implemented in Websphere applications, which are available from International Business Machines Corporation. A deployment manager is already present in which this deployment manager obtains and stores configuration information for different servers within the network. If the node is considered to be trusted, then the deployment manager may automatically update the Web server's version in addition to the configuration information. The scheduling of updates is controlled from a live update client process located at the client. This process controls the updating of data processing systems, such as trusted nodes. These nodes are ones that trust the live update client process to execute commands on behalf of the node to perform updates.

Turning now to FIG. 4, a block diagram illustrating components used in an automatic software update of nodes in a network data processing system is depicted in accordance with a preferred embodiment of the present invention. In FIG. 4, supplier environment 400 provides updates to client network 402 on an automatic basis using the mechanism of the present invention. Live update server 404 in supplier environment 400 distributes updates to live update client 406 in client network 402.

In this example, live update server 404 includes internal Web site server process 408, rules engine 410, Web services interface 412, and product repository 414. Internal Web site server process 408 is employed to receive updates for distribution. In these examples, updates include the software and prerequisite data needed to install the software. This software may take various forms, such as a new application, a patch, or an efix. Product repository 414 is used to store the software as well as prerequisite information.

Customer access information 418 is used to determine what products are accessible by a customer. In the illustrative examples, this customer access information includes an inventory of the customer network, client network 402 in these examples, as well as licensing information used to determine what software is authorized for a customer. Web services interface 412 provides an interface to distribute software to clients as well as receive requests from clients. In distributing updates, live update server 404 will send update list to clients through web server interface 412. This update list also may include prerequisite information to allow clients to determine what additional software may be needed to update a particular application for which an update request is made. This interface may work in either or both a push mechanism and a pull mechanism for distributing software.

Live update client 406 includes internal Web site 420, Web services interface 422, product repository 424, rules engine 420, and adapter 426. Internal Web site 414 is employed to initiate and schedule updates. For example, update schedule 424 may be sent by an administrator or manager of client network 402 to schedule updates for software received from a supplier or alternatively to request updates on some scheduled basis. This schedule may be based on some period of time set by the administrator or in response to some event depending on the particular implementation. Initially, a list of updates with prerequisite information is received at the client site. From this information, updates may be identified and requested by the client.

Web services interface 422 provides an interface from client network 402 to live update server 404 in supplier environment 400. Product repository 424 is used to store updates received from live update server 404 until those updates are to be sent for distribution to nodes within client network 402. Rules engine 428 is employed to analyze the environment within client network 402. For example, rules engine 428 may initiate the gathering of inventories from various nodes, such as nodes 430, 432, and 434 within client network 402. These nodes may be implemented using a client computer or data processing system, such as data processing system 300. In these examples, trusted nodes include nodes 430, 432, and 434. A trusted node in the illustrative examples is a node for which the update process has authentication information, such as a user name and password. In these examples, trusted node trusts the update process, such as adapter 442 in region 443 to execute commands on behalf of the node. Live update client 406 is a process executing on a server, such as data processing system 200 in FIG. 2. Live update server 404 may be implemented in software executing on a data processing system, such as data processing system 200 in FIG. 2.

In this example, supplier site 436 includes a product database 438. This product database contains software, patches, and efixes as well as prerequisites created by a party other than the customer who owns client network 402. When a software update is generated, this software update may be sent to live update server 404 for distribution to customers. The interface is through internal Web site server process 408 in the illustrative examples. As can be seen, software and prerequisite data 440 are sent from supplier site 436 to internal Web site server process 408. When this update is received, internal Web site server process 408 stores the update within product repository 414.

In these examples, software updates are performed by first sending a list of updates with prerequisite information regarding the updates. This prerequisite information includes, for example, patches, modules, or other requirements needed to install the update. Based on this list, client's request updates from live update server 404. Software and prerequisite data 440 may be distributed to customers through a push or pull mechanism. In the event that a pull mechanism is employed, a request is received from live update client 406 in response to some event that is scheduled, such as through update schedule 426. Upon receiving this request at Web services interface 412, rules engine 410 determines whether the customer is to receive this requested update.

An additional benefit of the mechanism of the present invention is an ability to control the distribution of updates, especially those updates that contain patches or efixes. Currently, customers may obtain patches or efixes even for unlicensed products. The mechanism of the present invention provides an added benefit in which requests are examined to determine whether the updates are authorized. Rules engine 410 checks customer access information 418 to determine whether the customer should receive the update. In these examples, customer access information 418 includes an inventory of the customer environment as well as licensing and product authorization information. As a result, rules engine 410 may determine whether the software should be returned in response to the request.

If the customer is authorized to receive the update, then the update is retrieved from product repository 414 by Web services interface 412. This update is then returned to live update client 406 through Web services interface 422. In response to receiving the update at Web services interface 422, the update is stored in product repository 424 for distribution within client network 402. This distribution is based on a schedule, such as update schedule 426. When an update is to be made, the update is sent to an adapter, such as adapter 442 in region 443.

In these examples, region 443 includes adapter 442, agent 444, software distribution 446, and inventory 448. Region 443 may be for example Tivoli Management Region (TMR), which is Tivoli software product available from International Business Machines Corporation (IBM) that controls a set of trusted nodes. Applications can be controlled and monitored via the TMR. TMR has authorization and the ability to execute commands on the nodes. Inventory 448 may be implemented using Tivoli Inventory, which is a software product from IBM that runs in the TMR on any of its trusted nodes. This component can examine the file system of a trusted node to determine what applications and patch levels are to be installed on a particular node. In these examples, software distribution 446 may be implemented using Software Distribution, which a software product from IBM that runs in the TMR and can push software updates to any trusted node. This component can then execute that software update so that the software update becomes installed on that trusted node.

In these examples, agent 444 is a Java based agent that resides in region 443 to allow for live updates. Agent 444 is an interface used to receive the updates from product repository 424 in live update client 406 and provides an interface to allow communications between live update client 406 and region 443.

If a push mechanism is used, rules engine 410 identifies clients from customer access information 418. Authorized customers are identified for a particular update. Rules engine 410 then causes initiation of the distribution of this update to the customers from product repository 414 through Web services interface 412 in these illustrative examples.

Additionally, the mechanism of the present invention also involves obtaining inventories from the different nodes in client network 402. In these examples, the inventories include an identification of the hardware and software on each of the nodes. The identification of hardware and software are used with the prerequisites to determine what patches and the order in which patches are to be installed.

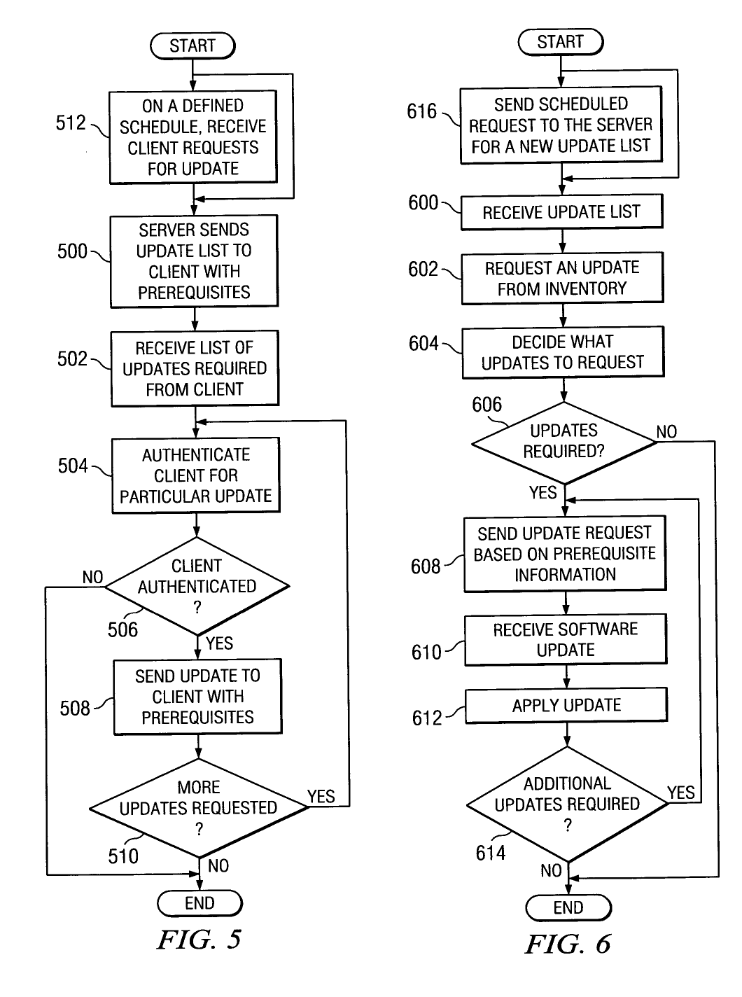

Turning next to FIG. 5 a flowchart of a process for sending an update to a client is depicted in accordance with a preferred embodiment of the present invention. The process illustrated in FIG. 5 may be implemented in a server process, such as live update server 404 in FIG. 4.

This process begins by the server sending an update list to client with prerequisite (step 500). These prerequisites include information needed for the updates on the list. These prerequisites may include for example, installation of selected patches, a presence of particular dynamic link library files, or other modules related to the software being updated. In response to this update list, a list of updates required is received from the client (step 502). The process then authenticates the client for the requested update (step 504). A determination is made as to whether the client hast been authenticate for this particular update (step 506).

If the client has been authenticated, the update is sent to the client along with the prerequisite (step 508). Then, determination is made as to whether additional updates have been requested from the client (step 510). If additional updates have been requested, the process returns to (step 504). Other wise the process terminates. The process also terminates if the client is not authenticated in (step 506).

In this manner, the server may push or send update lists to clients using the process in FIG. 5. Additionally, this process may occur on a pull basis. In this instance, the process begins by receiving client requests for updates on a defined schedule (step 512). With process then proceeding step 500 as described above.

Turning now to FIG. 6, a flowchart of the process for receiving updates from a server is depicted in accordance with a preferred embodiment of the present invention. The process illustrated in FIG. 6 may be implemented in a client process, such as live update client 406 in FIG. 4.

A process begins by receiving an update list (step 600). A request for an update of the software inventory is made (step 602). This inventory may be requested from the different nodes in a client network. Based on this product list and the inventory, updates are selected and requested (step 604). Step 604 may be implemented by using a rules engine, such as rules engine 428 in FIG. 4. Further, information from the product list and the inventory are used to decide what updates should be requested. The inventory requested may be stored in a database, such as product repository 424.

Next, a determination is made as to whether updates are required (step 606). If updates are required, a request for a product of update is made based on the pre information (step 608). For example, a particular update may require installation of a particular patch before the update may be installed. This case, both the patch and the update are requested.

Then, the software update is received (step 610). The update is then applied (step 612). Step 612 may be implemented using a software distribution mechanism as described with respect to region 443 in FIG. 4. A determination is then made as to whether additional updates are required. If additional updates are required, the process returns to (step 608) to request this update. Otherwise, the process terminates. The process also terminates in (step 606) if no updates are required.

The process illustrated in FIG. 6 is shown using a push mechanism in which the product list is received from a server without a request being made. Alternatively, the process may be going with what client sending a scheduled request to the server for a new update list (step 616). With the process then proceeding to (step 600) as described above.

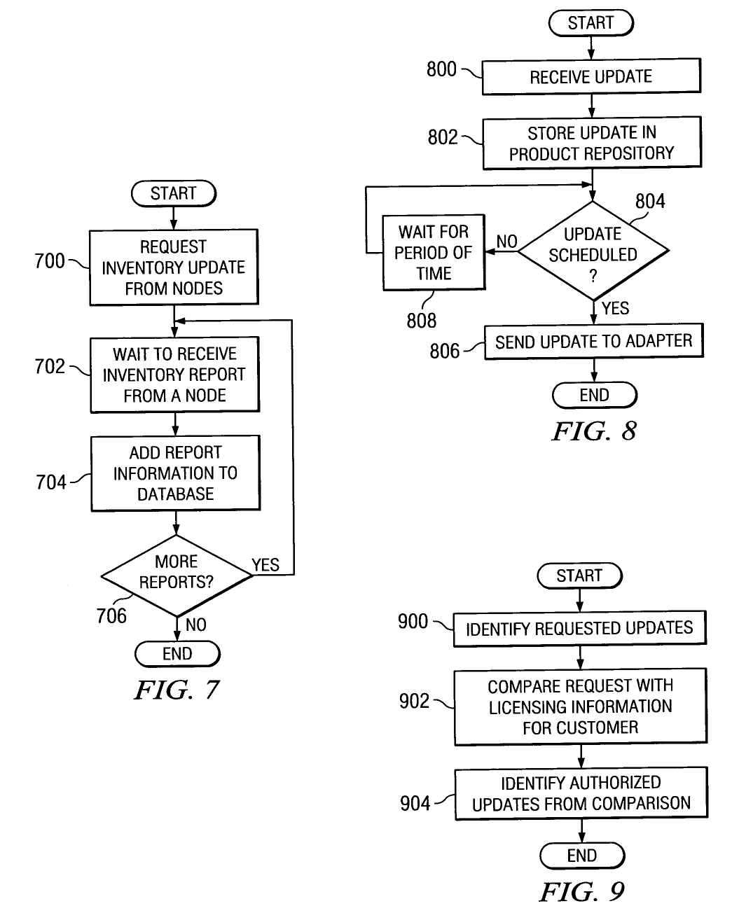

With reference now to FIG. 7, a flowchart of a process for obtaining inventory updates is depicted in accordance with a preferred embodiment of the present invention. The process illustrated in FIG. 7 may be implemented in a client server, such as live update client server 406 in FIG. 4. This process is a more detailed illustration of step 602 in FIG. 6.

The process begins by requesting an inventory update from nodes in the network (step 700), and waits to receive an inventory (step 702). When a report is received, this report is added to an inventory database (step 704). This inventory database may be located in a database, such as product repository 404 in live update client 406 in FIG. 4. Thereafter, a determination is made as to whether more reports are expected (step 706). If more reports are expected, the process returns to step 702. Otherwise, the process terminates.

With reference now to FIG. 8, a flowchart of a process for requesting an inventory update is depicted in accordance with a preferred embodiment of the present invention. The process illustrated in FIG. 8 may be implemented in a client process, such as live update client 406 in FIG. 4. In particular, the process depicted in FIG. 8 is a more detailed description of step 610 and 612 in FIG. 6.

The process begins by receiving an update (step 800). In these examples, the update includes the software, such as a patch or efix as well as prerequisites needed to install the software. The update is then stored in a product repository on the client network (step 802). A determination is then made as to whether the update is scheduled for initiation at the present time (step 804). If the update is scheduled, then the update is sent to the adapter for distribution and installation (step 806) with the process terminating thereafter.

With reference again to step 804, if the update is not scheduled for implementation at this time, then the process waits for a period of time (step 808) and then returns to step 804.

Turning now to FIG. 9, a flowchart of a process used for identifying authorized customer updates is depicted in accordance with a preferred embodiment of the present invention. The process illustrated in FIG. 9 may be implemented in a rules engine, such as rules engine 410 in FIG. 4. This illustrated process may be used in conjunction with the steps described in FIG. 5 to identify what applications a client may update as well as how many updates may be obtained. In particular, the steps illustrated in FIG. 9 are a more detailed description of steps 504 and 506 in FIG. 5. The process begins by identifying requested updates (step 900). The requested updates are received in a client request in live update server, such as live update server 404 in FIG. 4. This request is compared with licensing information for the customer (step 902). This comparison is used to determine what particular software or updates that the client or customer is authorized to obtain. The authorized updates are identified from the comparison (step 904) with the process terminating thereafter. This identification is used to determine what updates are to be sent to the client.

Thus, the present invention provides an improved method, apparatus, and computer instructions for automatic software updates of nodes in a network data processing system. The mechanism of the present invention involves using a live update server as well as a live update client to distribute updates from a supplier to a customer. The mechanism of the present invention allows for the supplier to control the distribution of software to customers. In these examples, all the steps may be logged for review at a later time. The mechanism of the present invention allows for increased control over which customers receive patches, efixes, or beta versions of products.

Additionally, the live update server of the present invention may easily gather product information for different nodes or computers running the software of the supplier. Further, by analyzing the customer environment and receiving an inventory of the environment, an up-to-date snapshot of the infrastructure may be used to provide additional solutions for the customer. For example, verification of the correct number of software licenses may be identified. Further, a prediction of future needs may be identified in a manner to allow the supplier to offer custom solutions to meet those needs.

Further, with customer privacy being a concern, live update client 406 in FIG. 4 may be configured in a manner to turn off analysis of the client environment if desired. In these examples, the analysis is provided through rules engine 428 in FIG. 4. Rules engine 428 obtains inventory information and Web services interface 422 transfers that information to live update server 404 in these examples.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMS, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

1. A method for managing software updates in a network data processing system, the method comprising:
identifying an update for an application for distribution to customers from a supplier; and
distributing the update through a supplier controlled process to a customer network based on customer access information for a customer owning the customer network.

2. The method of claim 1, wherein the distributing step is implemented using at least one of a push mechanism and a pull mechanism.

3. The method of claim 1 further comprising:
obtaining an inventory of the customer network; and
updating customer access information for the customer using the inventory.

4. The method of claim 1, wherein the customer access information includes licensing information for the customer.

5. The method of claim 1, wherein the distributing step includes:
denying a request for the application from the customer when the customer access information indicates that the customer is an unauthorized customer of the application.

6. The method of claim 1, wherein the identifying step and the distributing step are implemented in a live update server.

7. The method of claim 1, wherein the update includes prerequisite information for the update.

8. The method of claim 1 further comprising:
receiving the update at a client update process; and
distributing the update to nodes in the customer network using the client update process.

9. A software distribution system comprising:
a customer database, wherein the client database stores customer access information used to identify what software updates are authorized for particular customers;
an update server process, wherein the update server process, controlled by a software organization, distributes software updates to customers based on customer access information and prerequisite information for installing the software updates; and
an update client process, wherein the client update process obtains a software update from the update server process for an authorized application and updates a data processing system using the update.

10. A data processing system for managing software updates in a network data processing system, the data processing system comprising:
a bus system;
a communications unit connected to the bus system;
a memory connected to the bus system, wherein the memory includes a set of instructions; and
a processing unit connected to the bus system, wherein the processing unit executes the set of instructions to identify an update for an application for distribution to customers from a supplier; and distribute the update through a supplier controlled process to a customer network based on customer access information for a customer owning the customer network.

11. A data processing system for managing software updates in a network data processing system, the data processing system comprising:
identifying means for identifying an update for an application for distribution to customers from a supplier; and
distributing means for distributing the update through a supplier controlled process to a customer network based on customer access information for a customer owning the customer network.

12. The data processing system of claim 11, wherein the distributing means are implemented using at least one of a push mechanism and a pull mechanism.

13. The data processing system of claim 11 further comprising:
obtaining means for obtaining an inventory of the customer network; and
updating means for updating customer access information for the customer using the inventory.

14. The data processing system of claim 11, wherein the customer access information includes an inventory of software on the customer network and licensing information for the customer.

15. The data processing system of claim 11, wherein the distributing means includes:
denying means for denying a request for the application from the customer when the customer access information indicates that the customer is not an authorized customer of the application.

16. The data processing system of claim 11, wherein the identifying means and the distributing means are implemented in a live update server.

17. The data processing system of claim 11, wherein the update includes prerequisite information for the update.

18. The data processing system of claim 11, wherein the distributing means is a first distributing means and further comprising:
receiving means for receiving the update at a client update process; and
second distributing means for distributing the update to nodes in the customer network using the client update process.

19. A computer program product in a computer readable medium for managing software updates in a network data processing system, the computer program product comprising:
first instructions for identifying an update for an application for distribution to customers from a supplier; and
second instructions for distributing the update through a supplier controlled process to a customer network based on customer access information for a customer owning the customer network.

20. The computer program product of claim 19 further comprising:
third instructions for obtaining an inventory of the customer network; and
fourth instructions for updating customer access information for the customer using the inventory.

21. The computer program product of claim 19, wherein the second instructions includes:
sub-instructions for denying a request for the application from the customer when the customer access information indicates that the customer is not an authorized customer of the application.
